(19) United States
(12) Patent Application Publication
(10) Pub. No.: US 2026/0326773 A1
(43) Pub. Date: Oct. 22, 2026

(54) CENTRAL CONTROL UNIT AND INTERACTING CONTROL DEVICE FOR AT LEAST ONE MOTORIZED BRAKING, DRIVING AND/OR STEERING DEVICE OF A VEHICLE

(71) Applicant: Robert Bosch GmbH, Stuttgart (DE)

(72) Inventors: Martin Marquart, Ludwigsburg (DE); Florian Haag, Ellhofen (DE); Nikolas Loeffelmann, Dielheim (DE)

(21) Appl. No.: 19/647,277

(22) Filed: Apr. 14, 2026

(30) Foreign Application Priority Data
Apr. 22, 2025 (DE) 10 2025 115 423.6

(51) Int. Cl. B60W 50/02; B60W 50/04

(52) U.S. Cl. CPC B60W 50/0205; B60W 50/045; B60W 2050/021

(57) ABSTRACT

A central control unit, an interacting control device, and a method for operating at least one motorized braking, driving and/or steering device of a vehicle. The method includes defining at least two actuating signals for an electric motor of the motorized braking, driving and/or steering device according to a specified cascade sequence using the central control unit; outputting at least one output signal including at least two of the defined actuating signals, by the central control unit to a control device of the motorized braking, driving and/or steering device; reading out the at least two actuating signals, taking into account the at least one output signal; executing at least one comparison algorithm for the joint assessment of at least two of the actuating signals; and outputting at least one motor control signal to the electric motor, taking into account at least one of the actuating signals.

### FIELD

The present disclosure relates to a central control unit for interacting with at least one control device for at least one motorized braking, driving and/or steering device of a vehicle, and to a control device for at least one motorized braking, driving and/or steering device of a vehicle. The present disclosure also relates to a control system for at least one motorized braking, driving and/or steering device of a vehicle and to a motorized braking, driving and/or steering device for a vehicle. Furthermore, the present disclosure relates to a method for operating at least one motorized braking, driving and/or Steering device of a vehicle.

### BACKGROUND INFORMATION

Conventional control strategies for operating a braking system of a vehicle are described, for example, in Germany Patent Application Nos. DE 10 2018 221 815 A1, DE 10 2020 202 477 A1, DE 10 2020 212 789 A1 and DE 10 2022 105 729 A1.

### SUMMARY

The present disclosure provides a central control unit having for interacting with at least one control device for at least one motorized braking, driving and/or steering device of a vehicle, a control device for at least one motorized braking, driving and/or steering device of a vehicle, a control system for at least one motorized braking, driving and/or steering device of a vehicle, a motorized braking, driving and/or steering device for a vehicle, and a method for operating at least one motorized braking, driving and/or steering device of a vehicle.

According to an example embodiment, a central control unit is provided for interacting with at least one control device for at least one motorized braking, driving and/or steering device of a vehicle, wherein the central control unit is designed and/or programmed such that: at least two actuating signals for an electric motor of the motorized braking, driving and/or steering device can be defined by means of the central control unit, taking into account at least one provided braking, driving and/or steering request signal of at least one sensor of the vehicle and/or of at least one automatic system of the vehicle, according to a specified cascade sequence such that each actuating signal in the cascade sequence is defined taking into account the at least one braking, driving and/or steering request signal and/or the at least one preceding actuating signal in the cascade sequence; and at least one output signal comprising at least two of the defined actuating signals (26) can be output to the control device by means of the central control unit.

The present disclosure provides advantageous possibilities for allowing/simplifying the outsourcing of functions of a control device used to control an electric motor of a motorized braking, driving and/or steering device of a vehicle to a central control unit of the particular vehicle. At the same time, by using the present disclosure, an error made by the central control unit in its evaluation/further processing of a braking, driving and/or steering request made by the driver and/or autonomously can be recognized as such with a high probability by the at least one interacting control device. Despite the outsourcing of functions from the control device to the central control unit, a vehicle operated by means of the central control unit and the at least one control device still meets high safety requirements. In particular, the conventional risk of an under-braked vehicle is low.

The possibility, as provided by the present disclosure, of outsourcing functions from the control device to the central control unit allows further development of the functions on the particular central control unit, in particular by allowing the implementation of functions of various motorized braking, driving and/or steering devices of the particular vehicle to be better adapted to one another. Furthermore, the use of the present disclosure allows functional development on the central control unit of the particular vehicle, which is independent of functional development on the at least one control device interacting with the central control unit. The present disclosure thus contributes significantly to the improvement of the control and resulting operation of the at least one motorized braking, driving and/or steering device of the vehicle using it.

A further advantage of the present disclosure is that it can be implemented by means of relatively simple programming/reprogramming of the particular central control unit and of the at least one control device interacting therewith. Therefore, using the present disclosure is not/is hardly associated with any additional costs.

In an advantageous embodiment, the control device is additionally designed and/or programmed such that, if it is determined, in a joint assessment of at least two of the actuating signals carried out by means of the control device, that at least one implausible or faulty signal is present, the following actuating signal of the at least two actuating signals in the cascade sequence can be determined to be an implausible or faulty signal. Accordingly, the preceding actuating signal of the at least two actuating signals in the cascade sequence can be determined to be a plausible signal. Such an interpretation of the at least two actuating signals is useful because an indication of a possible error detected in the joint assessment of the at least two actuating signals by means of the control device is highly probably attributable to a made by the central control unit when defining the following actuating signal in the cascade sequence.

Preferably, the control device is additionally designed and/or programmed such that, instead of a actuating signal determined to be an implausible or faulty signal, a substitute signal can be defined by means of the control device, taking into account the at least one preceding actuating signal in the cascade sequence, wherein the at least one motor control signal can be output to the electric motor of the motorized braking, driving and/or steering device by means of the control device, additionally taking into account the at least one defined substitute signal. The embodiment of the control device described here can therefore not only detect an error made by the central control unit, but also correct it such that reliable control of the electric motor of the motorized braking, driving and/or steering device is still ensured.

As an advantageous development, the control device can additionally be designed and/or programmed such that a joint assessment of at least two of the actuating signals can be carried out by means of the control device, additionally taking into account data provided by at least one monitoring component of the motorized braking, driving and/or steering device. The embodiment of the control device described here can thus advantageously utilize the fact that it is conventionally often already connected to the at least one monitoring component such that it receives its data.

Alternatively or additionally, the control device can also comprise a memory device on which information about the motorized braking, driving and/or steering device, about at least one further vehicle device of the vehicle and/or about the vehicle is stored, wherein the control device is additionally designed and/or programmed such that a joint assessment of at least two of the actuating signals can be carried out by means of the control device, additionally taking into account the information stored on the memory device. In this way, the control of the electric motor of the motorized braking, driving and/or steering device can also be improved by means of the embodiment of the control device described here.

The advantages described above are also ensured in a control system for at least one motorized braking, driving and/or steering device of a vehicle having such a central control unit and at least one corresponding control device.

A motorized braking, driving and/or steering device for a vehicle having a corresponding control device also produces the advantages described above.

Furthermore, carrying out a corresponding method for operating at least one motorized braking, driving and/or steering device of a vehicle also creates the advantages described above. It is expressly pointed out that the method for operating at least one motorized braking, driving and/or steering device of a vehicle can also be developed according to the embodiments of the control device explained above.

Preferably, when the method is carried out, the at least one output signal is output by the central control unit to the control device of the motorized braking, driving and/or steering device via bus communication. The advantages of bus communication can thus also be used for the interaction of the central control unit and the at least one control device.

### BRIEF DESCRIPTION OF THE DRAWINGS

Further features and advantages of the present disclosure will be explained in the following with reference to the figures.

FIG. 1 is a schematic representation of example embodiments of the central control unit and of the at least one control device interacting therewith.

FIG. 2 is a flowchart for explaining an example embodiment of the method for operating at least one motorized braking, driving and/or steering device of a vehicle.

### DETAILED DESCRIPTION OF EXAMPLE EMBODIMENTS

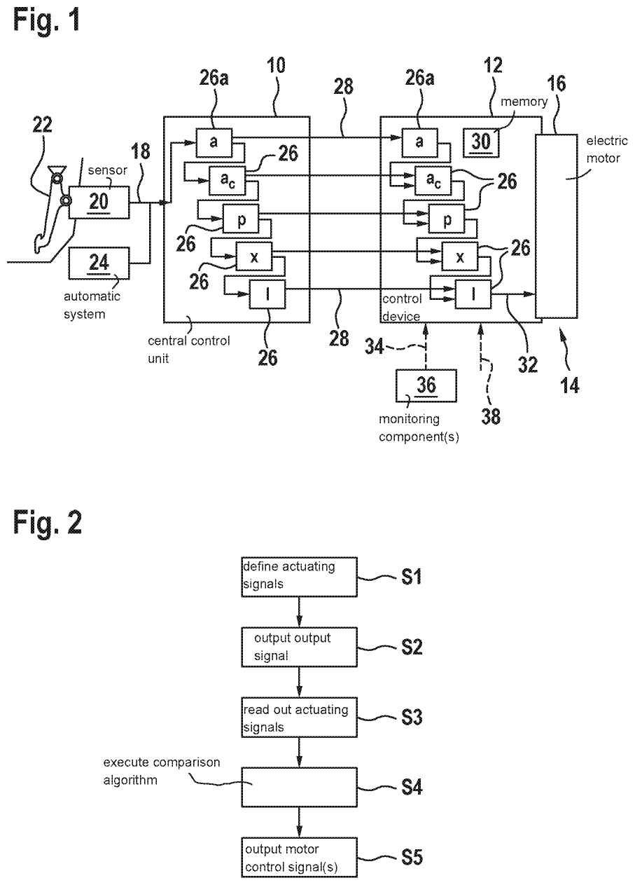

FIG. 1 is a schematic representation of embodiments of the central control unit and the at least one control device interacting therewith.

The central control unit 10 shown schematically in Fig. la can interact with at least one control device 12 of at least one (only partially sketched) motorized braking, driving and/or steering device 14 of a vehicle/motor vehicle. It should be noted that the usability of the central control unit 10 and the at least one control device 12 is not limited to any specific vehicle type/motor vehicle type of the vehicle/motor vehicle equipped with the at least one motorized braking, driving and/or steering device 14.

A plurality of different vehicle components can also be used for the at least one motorized braking, driving and/or steering device 14, of which only its electric motor 16 is shown in FIG. 1a. The term “the at least one motorized braking, driving and/or steering device 14” can mean (almost) any vehicle component that has its (own) electric motor 16 and by means of which the vehicle equipped therewith can be braked, driven and/or steered. The at least one motorized braking, driving and/or steering device 14 can be, for example, a motorized brake pressure building device, an electromechanical brake (EMB), an electric drive motor, an injection valve device of an internal combustion engine, and/or a steering system. Specifically, a motorized brake pressure building device can be a BWA (brake-by-wire) device, an IPB (integrated power brake) device, an electromechanical brake booster (iBooster) that can be or is positioned upstream of a master brake cylinder of a hydraulic braking system, and/or at least one pump of a hydraulic braking system (such as ESP) equipped with a common pump motor. However, the examples listed here of the at least one motorized braking, driving and/or steering device 14 are not to be interpreted as exhaustive.

By means of the central control unit 10, at least one provided braking, driving and/or steering request signal 18 can be evaluated. The at least one braking, driving and/or steering request signal 18 can, for example, be output by at least one sensor 20 of the vehicle to the central control unit 10. FIG. 1a shows, only by way of example, a sensor 20 attached to a brake pedal 22, such as a rod travel sensor and/or a driver brake force sensor, as an example of the at least one sensor 20. However, the term “the at least one sensor 20” can mean any vehicle sensor system by means of which a braking request from the driver, an acceleration request from the driver and/or a steering request from the driver can be detected and output as a corresponding braking, driving and/or steering request signal 18. Alternatively, the at least one braking, driving and/or Steering request signal 18 can also be output to the central control unit 10 by at least one automatic system 24 of the vehicle, by means of which the vehicle can be braked, accelerated and/or steered autonomously. The at least one automatic system 24 can be, for example, a driver assistance system, such as specifically adaptive cruise control, and/or an autonomous driving automatic system.

The central control unit 10 is designed and/or programmed such that at least two actuating signals 26 for the electric motor 16 of the motorized braking, driving and/or steering device 14 can be or are defined by means of the central control unit 10, taking into account the at least one provided braking, driving and/or steering request signal 18, according to a specified cascade sequence. By means of the design and/or programming of the central control unit 10, it is ensured that each actuating signal 26 in the cascade sequence is defined taking into account the at least one braking, driving and/or steering request signal 18 and/or the at least one preceding actuating signal 26 in the cascade sequence. Preferably, the cascade sequence begins with an actuating signal 26a read out from the at least one provided braking, driving and/or steering request signal 18. In the example of FIG. 1a, the central control unit 10 reads out, for example, a target vehicle deceleration a from the at least one provided braking, driving and/or steering request signal 18 and then, for example, uses the braking, driving and/or steering request signal 18 output by the sensor 20 of the brake pedal 22 to successively define a target vehicle deceleration ac corrected by a specified offset, a pedal position p of the brake pedal 22, at least one intermediate value x, and finally a target current strength I of a motor current to be supplied to the electric motor 16. However, the cascade sequence in FIG. 1a is to be interpreted only by way of example.

For at least two of the actuating signals 26 defined by the central control unit 10, at least one output signal 28 is then created such that the at least one output signal 28 comprises the at least two actuating signals 26. Preferably, the at least one output signal 28 also comprises the at least one actuating signal 26a read out from the at least one provided braking, driving and/or steering request signal 18. The at least one output signal 28 can in particular comprise all actuating signals 26 read out and defined by the central control unit 10. The at least one output signal 28 can then be output to the control device 12 by means of the central control unit 10. Preferably, the central control unit 10 and the control device 12 interacting therewith are designed and/or programmed such that the at least one output signal 28 can be or is output by the central control unit 10 to the control device 12 via bus communication. The at least one output signal 28 can therefore in particular be a bus signal. It is also noted here that a single signal or multiple signals can be output as the at least one output signal 28 to the control device 12.

The at least two actuating signals 26 that are comprised in the at least one output signal 28 can be read out by means of the control device 12. Provided that the at least one output signal 28 comprises all actuating signals 26 read out and defined by the central control unit 10, all actuating signals 26 read out and defined by the central control unit 10 can also be read out from the at least one output signal 28 by means of the control device 12 according to the specified cascade sequence. It is expressly pointed out here that the at least one output signal 28 can also comprise the at least one actuating signal 26a read out from the at least one provided braking, driving and/or steering request signal 18. The control device 10 thus optionally also has the at least one actuating signal 26a “contained” in the at least one braking, driving and/or steering request signal 18.

In addition, the control device 12 is designed and/or programmed such that at least one specified comparison algorithm also can be or is executed by means of the control device 12. The at least one comparison algorithm can, for example, be saved/stored on a memory device 30, which is only shown schematically, of the control device 12. The at least one specified comparison algorithm means an algorithm by means of which, based on a joint assessment of at least two of the actuating signals 26, it can be determined for at least one of the actuating signals 26 whether the particular actuating signal 26 is an implausible or faulty signal. The control device 12 is therefore suitable for monitoring/checking the at least two actuating signals 26 received by means of the at least one output signal 28 and for detecting any possible fault in the central control unit 10.

Furthermore, at least one motor control signal 32 can be output to the electric motor 16 of the motorized braking, driving and/or steering device 14 by means of the control device 12, at least taking into account at least one of the actuating signals 26. Preferably, by means of the design and/or programming of the control device 12, it is ensured that the at least one motor control signal 32 is output to the electric motor 16 disregarding the at least one actuating signal 26 which is determined by the control device 12 to be an implausible or faulty signal. In other words, the at least one actuating signal 26 that is determined by the control device 12 to be an implausible or faulty signal can be prevented/excluded from being taken into account when the at least one motor control signal 32 is output to the electric motor 16.

The control device 12 thus implements monitoring of the central control unit 10 when said central control unit defines the at least two actuating signals for the electric motor 16 of the motorized braking, driving and/or steering device 14. Therefore, an error that may have been made by the central control unit 10 in defining the at least two actuating signals 26 can be detected and “corrected out” by the control device 12. This contributes significantly to the more reliable and safe control of the electric motor 16 of the motorized braking, driving and/or steering device 14. The vehicle equipped with the central control unit 10 and the control device 12 thus offers its driver not only good driving comfort, but also a high safety standard.

The electric motor 16 can be reliably and effectively controlled by means of the at least one motor control signal 32 output by the control device 12. The at least one motor control signal 32 output by the control device 12 can be, for example, a motor current supplied to the electric motor 16 with an actual current strength corresponding to the target current strength I.

The equipping of the control device 12 described here, with its at least one comparison algorithm, creates a high safety standard even when functions are transferred between the central control unit 10 and the control device 12. The corresponding functions can optionally be supplied by a supplier of the units 10 and 12, by the vehicle manufacturer itself and/or by another supplier. It is expressly pointed out that a plurality of diverse functions can be implemented as functions on the central control unit 10 and the at least one control device 12.

A particular advantage of the design and/or programming described here of the central control unit 10 and the at least one control device 12 interacting therewith is that the central control unit 10 and the particular control device 12 interacting therewith can use the same software. The amount of work required for programming the central control unit 10 and the at least one control device 12 interacting therewith is therefore comparatively low. Furthermore, the possibility of using the same software for both the central control unit 10 and the at least one interacting control device 12 simplifies so-called FOTA (“flashing over the air”) activities in field operation.

Preferably, the control device 12 is additionally designed and/or programmed such that, if it is determined, in a joint assessment of at least two of the actuating signals 26 carried out by means of the control device 12, that at least one implausible or faulty signal is present, the following actuating signal 26 of the at least two actuating signals 26 in the cascade sequence can be or is determined to be an implausible or faulty signal. Accordingly, if it is determined, in a joint assessment of at least two of the actuating signals 26 carried out by means of the control device 12, that at least one implausible or faulty signal is present, the preceding actuating signal 26 of the at least two actuating signals 26 in the cascade sequence can be determined to be a plausible signal. This is useful because, if it is determined that at least one implausible or faulty signal is present, it can be assumed with a high degree of probability that this is attributable to an error made by the central control unit 10 in defining the following actuating signal 26 in the cascade sequence.

For example, if the control device 12 determines, in a joint assessment of the target vehicle deceleration a with the corrected target vehicle deceleration ac, that at least one of the two actuating signals 26 is implausible or faulty, the corrected target vehicle deceleration ac is interpreted as an implausible or faulty signal by the control device 12, since a fault has evidently occurred in the central control unit 10 when the corrected target vehicle deceleration ac was defined taking into account the target vehicle deceleration a. Likewise, if an implausibility or error is detected by the control device 12 in a joint assessment of the corrected target vehicle deceleration ac with the pedal position p of the brake pedal 22, the pedal position p can be determined to be an implausible or faulty signal, while the corrected target vehicle deceleration ac may be interpreted as a plausible signal.

However, the at least one comparison algorithm that can be executed by means of the control device 12 is not limited to a joint assessment of two actuating signals 26 adjacent in the specified cascade sequence. For example, the pedal position p can also be “compared” with a target motor force (as the at least one intermediate value x) to be provided by the electric motor 16 of the motorized braking, driving and/or steering device 14. For example, if the pedal position p is at 18 mm (millimeters), while the target motor force to be provided by means of the electric motor 16 is 3 N (newtons), the control device 12 can recognize that at least one of the two actuating signals 26 is an implausible or faulty signal. Accordingly, the target motor force to be provided by means of the electric motor 16 can then be recognized by the control device 12 as an implausible or faulty signal, while the pedal position p may still be interpreted by the control device 12 as a plausible signal.

As an advantageous development, the control device 12 can additionally be designed and/or programmed to define a substitute signal instead of an actuating signal 26 that is determined to be an implausible or faulty signal. The definition of the particular substitute signal can be carried out by means of the control device 12, taking into account the at least one actuating signal 26 that precedes in the cascade sequence and is read out from the at least one output signal 28. If necessary, the at least one motor control signal 32 can be or is output to the electric motor 16 of the motorized braking, driving and/or steering device 14 by means of the control device 12, additionally taking into account the at least one defined substitute signal.

The at least one comparison algorithm that can be executed by means of the control device 12 can, for example, be carried out by comparing one of the at least two actuating signals 26 “compared” with one another with a normal value or a normal value range, which is defined taking into account the at least one other actuating signal 26 of the at least two actuating signals 26 “compared” with one another. Corresponding monitoring can therefore be carried out at the signal level, with checksums and/or with a defined value range. Monitoring can take place at both the software level and the physical/functional level. For monitoring, a sufficiently large tolerance threshold can be used to avoid incorrect degradation of at least one actuating signal 26.

In a particularly advantageous embodiment, the control device 12 is also suitable for carrying out a joint assessment of at least two of the actuating signals 26, additionally taking into account data 34 provided by at least one monitoring component 36 of the motorized braking, driving and/or steering device 14. The at least one monitoring component 36 can mean, for example, a sensor component suitable for measuring at least one physical variable at the particular braking, driving and/or steering device 14. For example, a temperature or brake pressure can be measured by means of the at least one monitoring component 36. Likewise, the at least one monitoring component 36 can also mean monitoring electronics of the particular braking, driving and/or steering device 14, by means of which a state of the motorized braking, driving and/or steering device 14 can be established. Optionally, the control device 12 can also be suitable for reading in data 38 that are output by the central control unit 10 and/or by another (not shown) control unit of the vehicle. For example, a vehicle weight and/or a current speed of the vehicle can be output as data 38 to the control device 12. In particular, the normal value or normal value range used when executing a comparison algorithm can also be defined/selected taking into account the respective data 34 and 38.

Alternatively or additionally, information about the motorized braking, driving and/or steering device 14, about at least one other vehicle device 22 of the vehicle and/or about the vehicle can also be stored on the memory device 30 of the control device 12. If necessary, the control device 12 is also designed and/or programmed to perform a joint assessment of at least two of the actuating signals 26, additionally taking into account the information stored on the memory device 30. In particular, the normal value or normal value range used when executing a comparison algorithm can also be defined/selected taking into account the particular information. The particular information can comprise, for example, a manufacturer of the brake pedal 22 and/or of the motorized braking, driving and/or steering device 14, a model of the brake pedal and/or of the motorized braking, driving and/or steering device 14. The control device 12 may also be designed and/or programmed to create, by means of the provided data 34 and 38 and/or the information stored on the memory device 30, a dynamic model that can be used to carry out a joint assessment of at least two of the actuating signals 26.

The central control unit 10 and its at least one control device 12 can form a control system for the at least one motorized braking, driving and/or steering device 14 of the vehicle. Alternatively, the control device 12 can also be present as a subunit of the motorized braking, driving and/or steering device 14. However, it should be noted that the design of the control device 12 as a structural subunit of the motorized braking, driving and/or steering device 14 is optional.

FIG. 2 shows a flowchart for explaining an embodiment of the method for operating at least one motorized braking, driving and/or steering device of a vehicle.

The feasibility of the method described below is not limited to a specific type of the at least one operated motorized braking, driving and/or steering device, or to a specific vehicle type/motor vehicle type of the vehicle/motor vehicle equipped therewith. Examples of the at least one motorized braking, driving and/or steering device have already been listed above.

In a method step S1, at least two actuating signals for an electric motor of the motorized braking, driving and/or steering device are defined, according to a specified cascade sequence by means of a central control unit of the vehicle. The at least two actuating signals are defined taking into account at least one provided braking, driving and/or steering request signal from at least one sensor of the vehicle and/or at least one automatic system of the vehicle. Each actuating signal in the cascade sequence is thereby defined taking into account the at least one braking, driving and/or steering request signal and/or the at least one preceding actuating signal in the cascade sequence. Examples of the at least one actuating signal have already been listed above.

In a subsequent method step S2, at least one output signal, which comprises at least two of the defined actuating signals, is output by the central control unit to a control device of the motorized braking, driving and/or steering device. Preferably, the at least one output signal is output by the central control unit to the control device of the motorized braking, driving and/or steering device via bus communication.

Subsequently, in a method step S3, the at least two actuating signals for the electric motor of the motorized braking, driving and/or steering device are read out by means of the control device according to the specified cascade sequence, taking into account the at least one output signal output by the central control unit. In a further method step S4, at least one comparison algorithm specified to the control device is executed by means of the control device for the joint assessment of at least two of the actuating signals. In this way, it can be or is determined for at least one of the actuating signals whether the particular actuating signal is an implausible or faulty signal.

In a further method step S5, at least one motor control signal is output to the electric motor of the motorized braking, driving and/or steering device by means of the control device, taking into account at least one of the read out and/or defined actuating signals of the cascade sequence. Carrying out the method described herein thus also provides the advantages explained above.

1-10. (canceled)

11. A central control unit for interacting with a control device for a motorized braking, driving and/or steering device of a vehicle, wherein the central control unit is configured such that:
the central control unit can define at least two actuating signals for an electric motor of the motorized braking, driving and/or steering device, taking into account at least one provided braking, driving and/or steering request signal at least one of: (i) of at least one sensor of the vehicle, or (ii) of at least one automatic system of the vehicle, according to a specified cascade sequence such that each actuating signal in the specified cascade sequence is defined taking into account the at least one provided braking, driving and/or steering request signal and/or at least one preceding actuating signal in the cascade sequence; and
the central control unit can output at least one output signal including at least two of the defined actuating signals to the control device.

12. A control device for a motorized braking, driving and/or steering device of a vehicle for interacting with a central control unit, wherein the central control unit can define at least two actuating signals for an electric motor of the motorized braking, driving and/or steering device, taking into account at least one provided braking, driving and/or steering request signal at least one of: (i) of at least one sensor of the vehicle, or (ii) of at least one automatic system of the vehicle, according to a specified cascade sequence such that each actuating signal in the specified cascade sequence is defined taking into account the at least one provided braking, driving and/or steering request signal and/or at least one preceding actuating signal in the cascade sequence, and wherein the central control unit can output at least one output signal including at least two of the defined actuating signals to the control device, wherein the control device is configured such that:
the control device can read out the at least two actuating signals for the electric motor of the motorized braking, driving and/or steering device, taking into account the at least one output signal output by the central control unit, according to the specified cascade sequence;
the control device can execute at least one specified comparison algorithm, wherein using the comparison algorithm, based on a joint assessment of at least two of the actuating signals, the control device can determine for at least one of the actuating signals whether the at least one of the actuating signals is an implausible or faulty signal; and
the control device can output at least one motor control signal to the electric motor of the motorized braking, driving and/or steering device, at least taking into account at least one of the at least two actuating signals.

13. The control device according to claim 12, wherein the control device is additionally configured such that, if it is determined, in the joint assessment of at least two of the actuating signals carried out by the control device, that at least one implausible or faulty signal is present, a following actuating signal of the at least two actuating signals in the cascade sequence can be determined to be an implausible or faulty signal.

14. The control device according to claim 12, wherein the control device is additionally configured such that, if an actuating signal is determined to be an implausible or faulty actuating signal, a substitute signal can be defined by the control device, taking into account at least one preceding actuating signal in the cascade sequence, and wherein the at least one motor control signal can be output to the electric motor of the motorized braking, driving and/or steering device using the control device, taking into account the at least one defined substitute signal in place of the actuating signal determined to be the implausible or faulty signal.

15. The control device according to claim 12, wherein the control device is additionally configured such that the joint assessment of at least two of the actuating signals can be carried out by the control device, additionally taking into account data provided by at least one monitoring component of the motorized braking, driving and/or steering device.

16. The control device according to claim 12, wherein the control device comprises a memory device on which information is stored about at least one of: (i) the motorized braking, driving and/or steering device, (ii) at least one further vehicle device of the vehicle, or (iii) the vehicle, and wherein the control device is additionally configured such that the joint assessment of the at least two of the actuating signals can be carried out by the control device, additionally taking into account the information stored on the memory device.

17. A control system for a motorized braking, driving and/or steering device of a vehicle, comprising:
a central control unit configured such that:
the central control unit can define at least two actuating signals for an electric motor of the motorized braking, driving and/or steering device, taking into account at least one provided braking, driving and/or steering request signal at least one of: (i) of at least one sensor of the vehicle, or (ii) of at least one automatic system of the vehicle, according to a specified cascade sequence such that each actuating signal in the specified cascade sequence is defined taking into account the at least one provided braking, driving and/or steering request signal and/or at least one preceding actuating signal in the cascade sequence, and
the central control unit can output at least one output signal including at least two of the defined actuating signals to a control device; and
at least one control device, each control device of the at least one control device being configured such that:
the control device can read out the at least two actuating signals for the electric motor of the motorized braking, driving and/or steering device, taking into account the at least one output signal output by the central control unit, according to the specified cascade sequence,
the control device can execute at least one specified comparison algorithm, wherein using the comparison algorithm, based on a joint assessment of at least two of the actuating signals, the control device can determine for at least one of the actuating signals whether the at least one of the actuating signals is an implausible or faulty signal, and
the control device can output at least one motor control signal to the electric motor of the motorized braking, driving and/or steering device, at least taking into account at least one of the at least two actuating signals.

18. A motorized braking, driving and/or steering device for a vehicle comprising:
a control device configured to interact with a central control unit, wherein the central control unit can define at least two actuating signals for an electric motor of the motorized braking, driving and/or steering device, taking into account at least one provided braking, driving and/or steering request signal at least one of: (i) of at least one sensor of the vehicle, or (ii) of at least one automatic system of the vehicle, according to a specified cascade sequence such that each actuating signal in the specified cascade sequence is defined taking into account the at least one provided braking, driving and/or steering request signal and/or at least one preceding actuating signal in the cascade sequence, and wherein the central control unit can output at least one output signal including at least two of the defined actuating signals to the control device, wherein the control device is configured such that:
the control device can read out the at least two actuating signals for the electric motor of the motorized braking, driving and/or steering device, taking into account the at least one output signal output by the central control unit, according to the specified cascade sequence;
the control device can execute at least one specified comparison algorithm, wherein using the comparison algorithm, based on a joint assessment of at least two of the actuating signals, the control device can determine for at least one of the actuating signals whether the at least one of the actuating signals is an implausible or faulty signal; and
the control device can output at least one motor control signal to the electric motor of the motorized braking, driving and/or steering device, at least taking into account at least one of the at least two actuating signals.

19. A method for operating a motorized braking, driving and/or steering device of a vehicle, comprising the following steps:
defining at least two actuating signals for an electric motor of the motorized braking, driving and/or steering device, taking into account at least one provided braking, driving and/or steering request signal of at least one sensor of the vehicle and/or of at least one automatic system of the vehicle according to a specified cascade sequence using a central control unit of the vehicle, wherein each actuating signal in the cascade sequence is defined taking into account at least one of: (i) the at least one braking, driving and/or steering request signal, or (ii) at least one preceding actuating signal in the cascade sequence;
outputting at least one output signal including at least two of the defined actuating signals, by the central control unit to a control device of the motorized braking, driving and/or steering device;
reading out the at least two actuating signals for the electric motor of the motorized braking, driving and/or steering device according to the specified cascade sequence, taking into account the at least one output signal output by the central control unit, using the control device;
executing at least one comparison algorithm, specified to the control device, using the control device for a joint assessment of at least two of the actuating signals, wherein the control device can determine for at least one of the actuating signals whether the at least one of the actuating signals is an implausible or faulty signal; and
outputting at least one motor control signal to the electric motor of the motorized braking, driving and/or steering device, taking into account at least one of the actuating signals of the cascade sequence.

20. The method according to claim 19, wherein the at least one output signal is output by the central control unit to the control device of the motorized braking, driving and/or steering device via bus communication.
